(19) United States
(12) Patent Application Publication
(10) Pub. No.: US 2020/0074177 A1
(43) Pub. Date: Mar. 5, 2020

(54) METHOD OF DISPLAYING A PRODUCT INSIDE A RETAIL PACKAGE

(71) Applicant: Super77, Inc., Columbus, OH (US)

(72) Inventors: Shaun Bosworth, Columbus, OH (US); Rainer Ziehm, Columbus, OH (US)

(73) Assignee: Super77, Inc., Columbus, OH (US)

(21) Appl. No.: 16/555,424

(22) Filed: Aug. 29, 2019

Related U.S. Application Data
(60) Provisional application No. 62/724,512, filed on Aug. 29, 2018.

(51) Int. Cl. G06K 9/00; G06K 9/62; G06T 13/80; G06T 19/00; G06T 7/73

(52) U.S. Cl. CPC G06K 9/00671; G06K 9/6232; G06T 2219/2004; G06T 19/006; G06T 7/74; G06T 13/80

(57) ABSTRACT

A method for displaying products inside a retail package using technology commonly referred to as augmented reality. The user aims a mobile device at a package, and the mobile device outputs a camera input onto a display screen while overlaying an animated version of the product. Additionally, a method for identifying the product itself via surface features and then overlaying an animated version of the product onto a display screen.

This non-provisional application claims priority to and the benefit of U.S. Provisional Patent Application No. 62/724,512, filed on Aug. 29, 2018, which is incorporated herein by reference.

### BACKGROUND

Augmented reality (AR) technology typically involves the layering of information provided by a computer with information seen by a user in real life. For example, augmented reality technology can be placed inside a headset, which can then overlay information about objects the user is seeing.

### SUMMARY

Presently disclosed is a method that enables a consumer to visualize a product inside a retail package, without the need to open said package. A user of a smart or mobile device, for example a smar tphone or tablet computer, pre-loads the device with an application. The application is capable of identifying a product's packaging by parsing the visual information provided by the mobile device's camera. The user points the mobile device at a packaged product with the application running. The application looks at the visual information from the camera and scans that information for high contrast feature points on the retail package. The application already contains samples of these feature points in a database, with each feature point being associated with a particular product. Once the application identifies the feature points, the application pulls the images of the associated product and that retail package. A visualization of the packaging is overlaid onto the display in the same position and orientation as the physical retail package. An animation may then be played based on the visualization, and an additional visualization of the product itself may be added. Therefore, the consumer can use the mobile device to look at a product contained inside a retail package even if the retail package is completely opaque.

Moreover, the disclosed method may provide a way for a consumer to obtain further information of the product included in the retail package. For example, the consumer may know that a particular series of figures is provided within the packaging, but does not know the exact figure packaged inside. The user may then use the above application to identify which particular figure is within the packaging.

The above disclosed method may be modified to apply to the product itself, rather than just the product's packaging. Instead of feature points, the application will instead look for surface features with a high contrast ratio or other kind of visually distinctive feature. The application can then overlay a virtual representation of the product onto the mobile device's screen. In this manner, additional information about the product can be shown, or the product may be shown doing something otherwise not possible. For example, an action figure can be animated to talk to the user or engage in other animated activities.

### BRIEF DESCRIPTION OF THE FIGURES

FIGS. 1A-1C illustrate a method for displaying a product inside a retail package;

FIGS. 2A -2E illustrate a series of display images as an example of a disclosed method for displaying a product inside a retail package;

FIG. 3 illustrates a flow chart process for identifying a product and overlaying additional information;

FIGS. 4A-4C illustrates a method for animating a product on a mobile display;

FIGS. 5A-5F illustrate a series of display images as an example of a disclosed method for animating a product on a mobile display; and

FIG. 6 illustrates a flow chart for identifying a product and overlaying additional information.

### DETAILED DESCRIPTION OF THE FIGURES

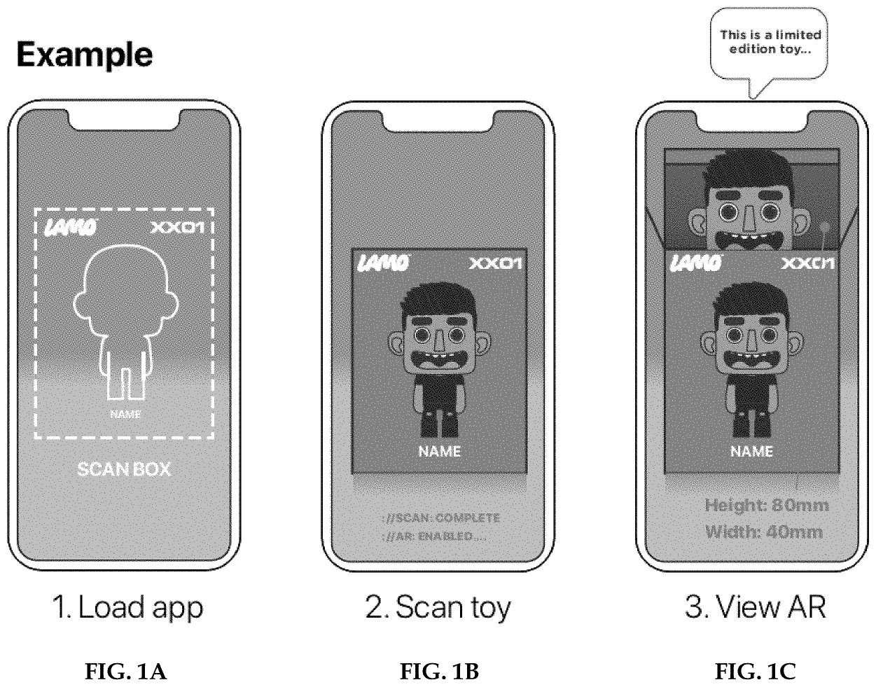

FIGS. 1A-1C illustrate the display of a mobile device as it initializes and runs an augmented reality application. FIG. 1A shows the display of the device during the beginning of an example augmented reality application. FIG. 1B illustrates the display as it would appear if the user pointed the device at a retail package. At this step, the application identifies feature points on the retail package. FIG. 1C shows the device overlaying an animation onto the packaging once the feature points and their position and orientation have been identified.

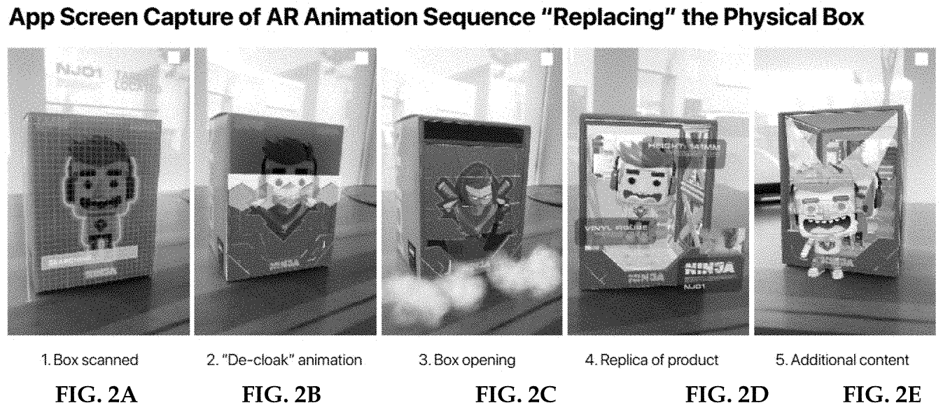

FIGS. 2A-2E illustrate a series of display images as an example of the disclosed method for displaying a product inside a retail package. FIG. 2A illustrates the display of a mobile device as the mobile device scans the visual input from a camera for feature points. FIGS. 2B and 2C illustrate the application as it identifies the feature points. The application is applying an animation over the visual information from the camera. The animation is positioned to appear as if it is the retail packaging, using the measured position and orientation of the feature points. FIG. 2D illustrates the application displaying an image of the product contained within the retail packaging. FIG. 2E illustrates the application showing the product becoming animated and providing additional information to the user.

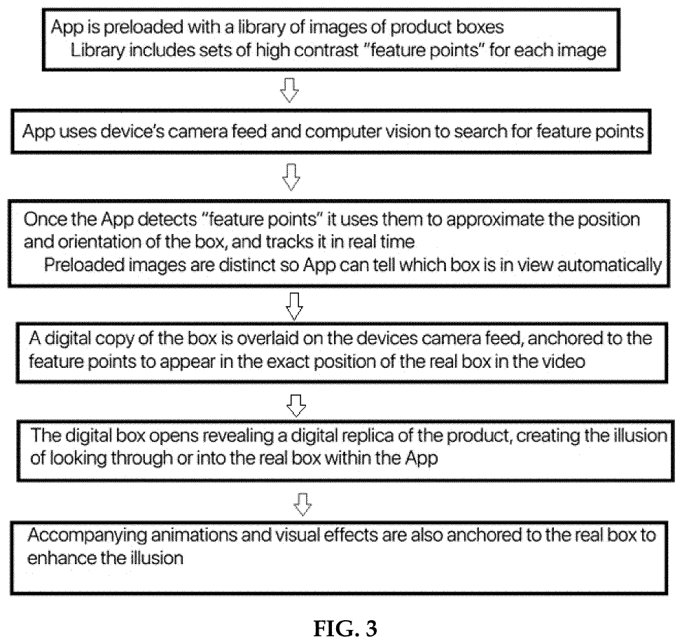

FIG. 3 illustrates a flow chart process for identifying a product and overlaying additional information. First, an application is preloaded with a library of images of product boxes. The library may include a set of high contrast feature points for each image. Second, the application uses the mobile device's camera feed and computer vision to search for feature points. Third, once the application detects the feature points and uses said feature points to approximate the position and orientation of the box, tracking these in real time. The preloaded images are sufficiently distinct in order to allow the application to determine which product box is in view automatically. Fourth, a digital copy of the product box is overlaid on the device's camera feed, anchored to the feature points to appear in the exact position of the physical product box in the video. Fifth, the digital product box opens revealing a digital replica of the product, creating the illusion of looking through or into the physical product box within the application. Finally, accompanying animations and visual effects are also anchored to the physical product box to enhance the illusion.

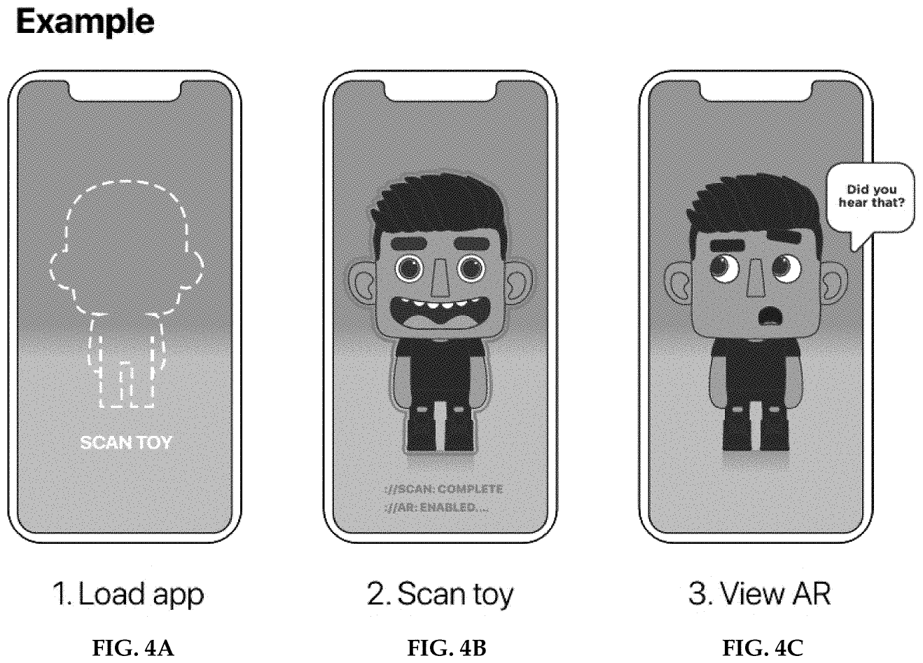

FIGS. 4A-4C illustrate an example method of animating a product on a mobile display. FIG. 4A shows the display of the device during the beginning of an example augmented reality application. FIG. 4B illustrates the display as said display would appear if the user pointed the device at a product. The application identifies the surface features on the retail package. FIG. 4C shows the device overlaying an animation onto the product once the surface features and their position/orientation have been identified.

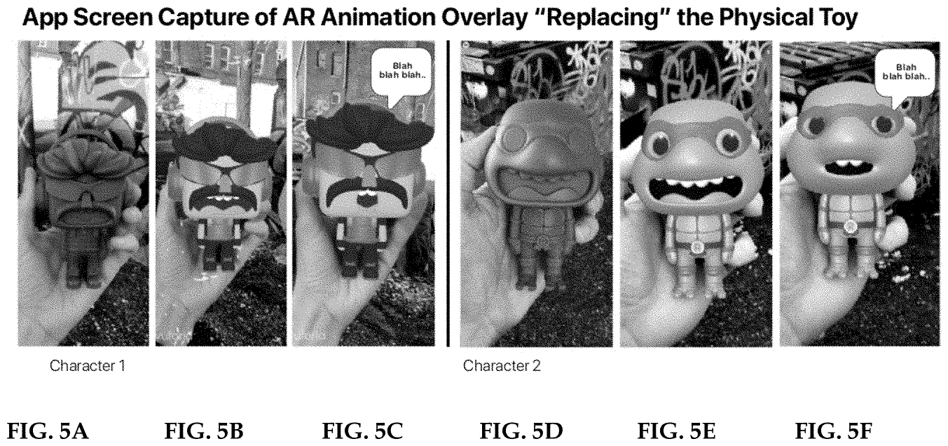

FIGS. 5A-5F illustrate a series of display images as an example of a disclosed method for animating a physical product. No ownership claims are made to the appearance of the physical products disclosed. Said physical products are being used for illustration purposes. FIGS. 5A and 5D show an example application screen when the user has positioned a physical product in sight of a camera on a mobile device. FIGS. 5B and 5E illustrate the application super-imposing virtual representations of the product over the physical product. FIGS. 5C and 5F illustrate the application animating the virtual representations of the product to make the physical product appear to be talking to the user.

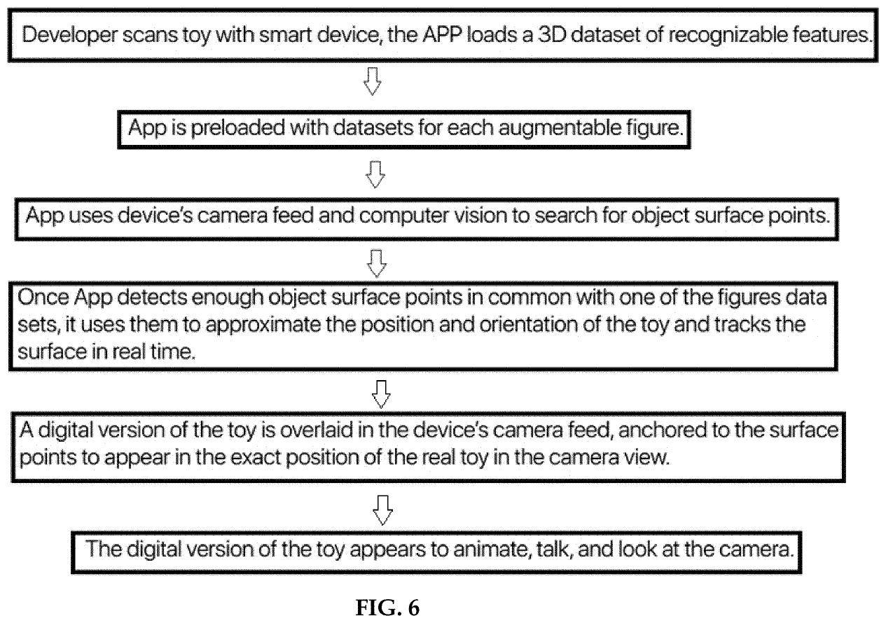

FIG. 6 illustrates a flow chart for identifying a product and overlaying additional information. First, a user may scan an augmentable physical product, for example a toy, with a mobile device, creating a 3D dataset of recognizable features. Other examples of augmentable physical products include: apparel, footwear, jewelry, accessories, tools consumer electronics, kitchen appliances, baby products, outdoor and recreational products, entertainment and media, grocery and confectionary, pet supplies, furniture and home goods. Second, the application is preloaded with datasets for each augmentable figure. Third, the application uses device's camera feed and computer vision to search for object surface points. Fourth, once the application detects enough object surface points in common with one of the figures data sets, the application uses them to approximate the position and orientation of the augmentable physical product and tracks the surface in real time. Fifth, a digital version of the product is overlaid in the device's camera feed, anchored to the surface points to appear in the exact position of the augmentable physical product in the camera view. Finally, the digital version of the augmentable physical product appears to animate, talk, and look at the camera.

What is claimed is:

1. A method for displaying a product inside a retail package, comprising the steps of:
aiming a mobile device with a camera at a retail package, said retail package comprising a physical structure, an artwork, at least one feature point and a product inside;
capturing a visual input of the retail package with the camera;
identifying within the visual input the at least one feature point;
super-imposing an image of the product onto the visual input, creating a modified visual input, wherein an apparent location of the image of the product correlates with a relative position of the product and the at least one feature point; and
outputting the modified visual input onto a display.

2. The method for displaying a product inside a retail package as claimed in claim 1, wherein the retail package is entirely opaque.

3. The method for displaying a product inside a retail package as claimed in claim 1, further comprising the step of pre-loading the mobile device with the image of the product and an image of the retail package.

4. The method for displaying a product inside a retail package as claimed in claim 1, wherein the at least one feature point is a portion of the artwork, said artwork with a high contrast ratio.

5. The method for displaying a product inside a retail package as claimed in claim 1, wherein the retail package further comprises a viewing window.

6. The method for displaying a product inside a retail package as claimed in claim 1, further comprising the step of overlaying an animation of the retail package over the visual input, prior to the step of super-imposing an image of the product onto the visual input.

7. The method for displaying a product inside a retail package as claimed in claim 1, wherein the image of the product is a three-dimensional model of the product.

8. The method for displaying a product inside the retail package as claimed in claim 1, wherein the artwork omits all human-readable information regarding the identity of the product.

9. The method for displaying a product inside the retail package as claimed in claim 1, wherein the product is a single species of product selected at random from a set comprising multiple species.

10. A method for displaying a product inside a retail package, comprising the steps of:
preloading an application into a mobile device, wherein the mobile device comprises a display and a camera, wherein the application comprises a full dataset of feature points corresponding to at least one physical retail package;
aiming the camera at a physical retail package, the physical retail package comprising an artwork, said artwork comprising a subset of feature points selected from the full dataset of feature points in the application;
obtaining a visual input of the physical retail package through the camera;
searching the visual input of the physical retail package for the subset of feature points and identifying the subset of the feature points present in the visual input;
comparing the identified subset of feature points against a database of products;
identifying a product represented by the identified subset of feature points;
approximating a position and an orientation of the physical retail package by comparing a measured location and a measured orientation of the subset of feature points;
overlaying the image within the visual input, the image placed in the position and orientation of the physical retail package;
applying an animation to the image; and
outputting the visual input to the display.

11. The method for displaying a product inside a retail package as claimed in claim 10, wherein the mobile device is a smartphone.

12. The method for displaying a product inside a retail package as claimed in claim 10, further comprising the step of creating the image from a three dimensional file.

13. The method for displaying a product inside a retail package as claimed in claim 10, further comprising the step of generating the image partially from a three dimensional file of the product.

14. The method for displaying a product inside a retail package as claimed in claim 10, wherein the artwork contains no human-readable information regarding an identity of the product.

15. The method for displaying a product inside a retail package as claimed in claim 14, wherein the physical retail package is entirely opaque.

16. The method for displaying a product inside a retail package as claimed in claim 10, wherein the full dataset of feature points comprises of Quick Response Codes.

17. The method for displaying a product inside a retail package as claimed in claim 10, wherein the full dataset of feature points are of high contrast.

18. A method for displaying an animation of a fixed product, comprising the steps of:
preloading an application into a mobile device, the application comprising a set of surface points, wherein the mobile device comprises a display and a camera;
aiming the camera at a fixed product, the fixed product comprising a subset of surface points selected from within the full set of surface points;
searching a visual input of the camera for the subset of surface points and identifying the subset of the surface points present in the visual input;
comparing the identified subset of surface points against a database of fixed products;
identifying the fixed product represented by the identified subset of surface points;
approximating a position and an orientation of the fixed product by comparing a measured location and a measured orientation of the subset of surface points;
overlaying an image within the visual input, the image placed relative to the position and orientation of the physical retail package;
applying an animation to the image; and
outputting the visual input to the display.
